(19) United States
(12) Patent Application Publication
(10) Pub. No.: US 2025/0216236 A1
(43) Pub. Date: Jul. 3, 2025

(54) A GAS FLOW MEASUREMENT DEVICE

(71) Applicant: BPC Instruments AB, Lund (SE)

(72) Inventor: Jing LIU, Lund (SE)

(21) Appl. No.: 18/851,399

(22) PCT Filed: Mar. 28, 2023
(86) PCT No.: PCT/SE2023/050273

§ 371 Date: Sep. 26, 2024

(30) Foreign Application Priority Data
Apr. 1, 2022 (SE) 2250415-3

(51) Int. Cl. G01F 3/30; G01F 3/26; G01F 15/07

(52) U.S. Cl. CPC G01F 3/30; G01F 3/26; G01F 15/07

(57) ABSTRACT

The present invention describes a gas volume and flow measurement device 1 comprising a flow cell compartment 2 with a definite and predefined 5 inner geometric volume, the flow cell compartment 2 having one gas accumulating end 3 and one lifting end 4 and having a pivoting element 5 enabling the flow cell compartment 2 to pivot upwards to release the gas contained therein and then downwards again to its initial position and operating by liquid displacement and according to the leverage effect, wherein said gas flow measurement device 1 also comprises a bubble counter unit 6.

### FIELD OF THE INVENTION

The present invention relates to a gas flow measurement device working by the principle of liquid displacement.

TECHNICAL BACKGROUND

Different types of liquid displacement gas flow measuring devices are known. For instance in WO 2010/120229 there is disclosed a measuring device for measuring an ultra-low gas flow, working by the principle of liquid displacement, wherein the measuring device comprises at least one cell comprising a gas inflow means, a gas compartment means with a predefined inner geometric physical volume and active volume, the gas compartment means having one gas accumulating end and one lifting end, the gas compartment means also defining a geometric gas collecting point inside of the gas compartment means during a gas filling cycle, the geometric gas collecting point moving further and further from the gas accumulating end to the lifting end during the gas filling cycle, and wherein the cell comprises a holding means having a pivoting element enabling the gas compartment means to pivot upwards when the geometric gas collecting point is positioned at the lifting end and the lifting force is larger than the down-pressing force at the lifting end, thereby releasing all of the accumulated gas in the gas compartment means, and then pivoting back to its initial standby position for new receipt and storage of gas during another gas filling cycle until next releasing sequence, and wherein the cell also comprises a sensor means provided to generate a signal and/or change the state of a signal when the gas compartment means is not in its initial standby position, wherein the gas storing capacity of the inside of the gas compartment means is larger at the gas accumulating end than at the lifting end and wherein the gas accumulating end has a higher vertical position than the lifting end at the initial standby position.

Furthermore, in WO 2017/200464 there is disclosed a similar device as disclosed above, however in this case the space compartment is a closed wet space compartment.

The present invention is directed to a gas flow measuring device with improved measuring accuracy and resolution, especially for ultra-low gas volume and flows.

### SUMMARY OF THE INVENTION

The latter stated purpose above is achieved by a gas volume and flow measurement device comprising a flow cell compartment with a definite and predefined inner geometric volume, the flow cell compartment having one gas accumulating end and one lifting end and having a pivoting element enabling the flow cell compartment to pivot upwards to release the gas contained therein and then downwards again to its initial position and operating by liquid displacement and according to the leverage effect, wherein said gas flow measurement device also comprises a bubble counter unit.

As should be understood from above, the gas volume and flow measurement device according to the present invention comprises both a pivotable flow cell compartment with a definite and predefined inner geometric volume and also a bubble counter unit. These two separate gas measuring principles are merged together in the device according to the present invention. This provides a gas flow measuring device with improved measuring accuracy and resolution, especially for ultra-low gas volume and flows.

Furthermore, the embedded and integrated bubble counter unit of the gas flow measuring device enables to count the number of gas bubbles generated and/or calculate the size of each bubble for each cycle of the flow cell compartment movement from its initial position to the gas releasing position. Therefore, according to one embodiment of the present invention, the bubble counter unit is arranged to count the number of gas bubbles generated and/or calculate the size of each bubble for each cycle of the flow cell compartment movement from its initial position to its gas releasing position.

### SPECIFIC EMBODIMENTS OF THE INVENTION

Some specific embodiments of the present invention are described below.

First of all, according to the present invention, the bubble counter is embedded in the flow cell flow cell compartment. The bubble counter and the liquid displacement flow cell are used together to provide maximal information of a certain gas volume and flow.

According to one embodiment, the bubble counter unit is arranged to count the number of gas bubbles generated and/or calculate the average size of at least some of the gas bubbles generated and/or the size of each individual bubble for each cycle of the flow cell compartment movement from its initial position to its gas releasing position. This allows to predict the average volume size of bubbles or the volume size of next released bubble. Both these alternatives are of value according to the present invention, as the information may be used to calculate ultra-low gas volumes and flows in a very accurate way. So there are two possible ways to calculate or predict bubble size according to the present invention. One is by calculating the average size of bubbles for each cycle of the flow cell compartment movement in order to predict the average size of bubbles for the next cycle of the flow cell compartment movement. The second one is by calculating the individual size of bubble by combing the calculation of average size of bubbles and time interval from the previous released bubble to the coming released bubble. In line with this, according to one embodiment of the present invention, the bubble counter unit is arranged to both count the number of gas bubbles generated and calculate the size of each bubble for each cycle of the flow cell compartment movement from its initial position to its gas releasing position. How both alternatives may be implemented is further described below in relation to the method embodiments according to the present invention.

According to yet another embodiment of the present invention, the bubble counter unit comprises one or more of a conductivity sensor, capacitive sensor, ultrasound, camera, optical coupler or any kind of light emitting diode and receiver, IR infrared emitter and receiver and LED-photo diode and photo transistor, preferably at least a pair of light-emitting diode and receiver, more preferably such a pair of light-emitting diode and receiver is arranged on a pathway from a bubble creation point to a bubble releasing point.

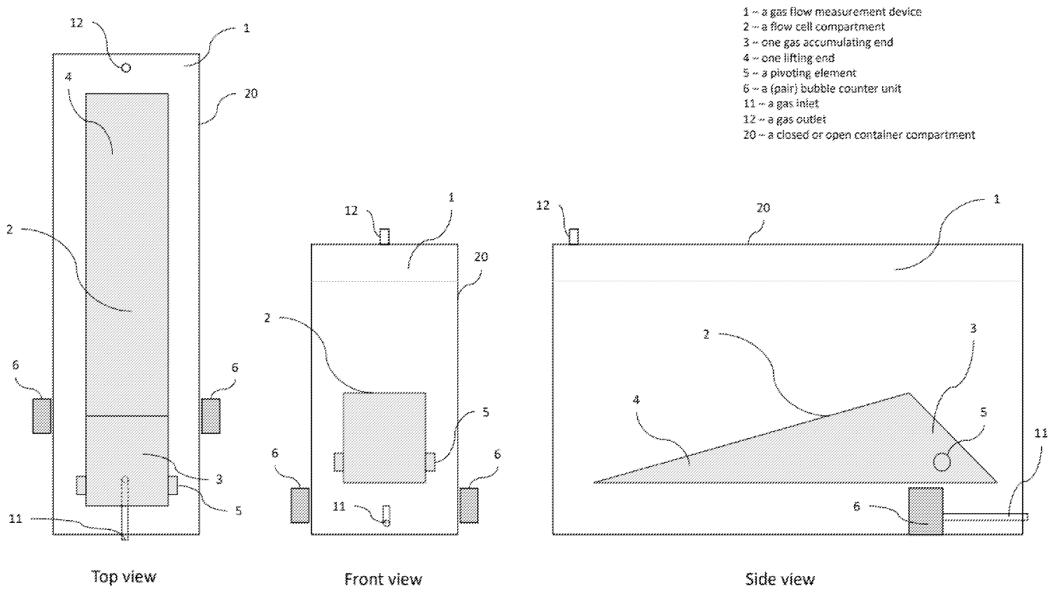

According to one embodiment, the bubble counter unit may be arranged in an external position with reference to the flow cell compartment, either inside of a closed container compartment (see FIG. 1) or as an external unit in the gas volume and flow measurement device according to the present invention.

There are several possibilities to place the detection sensor for bubble counting and even bubble size measurement. If a light emitting diode and receiver or similar sensor are used, possible solutions for placing sensor include:
On a pathway or on site of a bubble creating point. In this case the light emitting diode and receiver are located in opposite side to each other.
Along a pathway of a bubble releasing from its creation point. In this case, the light emitting diode and receiver are also located in opposite side to each other.
According to another possibility, the light emitting diode and receiver are located on the same side, and the detection is based on a light reflection by the bubble to the receiver.
According to yet another possibility, the light emitting diode and receiver are located neither in opposite side nor same side, instead it is positioned with a pre-defined angle, and the detection is based on light reflection by the bubble to the receiver.

According to the present invention a light emitting diode and receiver may be used for measuring/calculating the size of each bubble, which may be performed by measuring the time required for a bubble to pass a light beam. This time is often in ms or ns, which as such implies that the requirement of the light emitting diode and receiver is high speed and quality.

It should be noted that to use and implement a light emitting diode and receiver in this way is optional according to the present invention.

Moreover, the present invention is not limited to only comprise one pair of light-emitting diode with corresponding detector, but may in fact have multiple pairs of light emitting diode and detector placed at different locations in the gas flow measurement device. These may in turn be placed in different positions according to above.

As mentioned above, the bubble counter unit may also be a camera unit or other optical sensing device. A camera or other optical sensing device may have several possible intended usages. It may be used to identify if a light emitting diode is working in case the light consists of wavelengths that cannot be detected by the human eye. A camera may also be used to record flows or for tracking purposes. A camera may also be used as a back-up for another type of bubble counter unit.

Moreover, combinations of different sensor are also very possible according to the present invention. For instance, a conductivity or capacity sensor, which utilizes that water and air have different conductivity capabilities, may be combined with another sensor, such as a camera or the like.

Furthermore, the type of flow cell may also vary according to the present invention. According to one embodiment of the present invention, the flow cell compartment is positioned in a closed container compartment where said closed container compartment is connected to the outside only via a gas inlet and a gas outlet. According to one specific embodiment, the bubble counter unit is a pair of light-emitting diode and receiver positioned to ensure no contact with liquid media in the closed container compartment. A pair of light-emitting diode and receiver is especially suitable for a closed container compartment as the pair of light-emitting diode and receiver may be placed outside the closed container compartment without direct contact with the liquid media in the closed container compartment.

According to one embodiment of the present invention, the bubble counter unit is arranged more or less perpendicular to a gas bubble generation position. The gas bubble generation position is suitably provided at the gas inlet. Therefore, according to one embodiment, the bubble counter unit is arranged more or less perpendicular to the gas inlet.

The present invention also refers to a method for performing a gas analysis measurement or a gas volume and/or flow measurement, where said method comprises directing a gas flow or gas sample to a gas flow measurement device according to the present invention.

Moreover, according to one specific embodiment of the present invention, the method involves using both the flow cell compartment and the bubble counter unit to measure the total gas volume and flow. From the methodology aspect, the present invention is directed to bubble counting with/without bubble size estimation combined with a gas volume measurement based on liquid displacement. The method according to the present invention provides a well-integrated combination of these two different principles, for gaining high measuring resolution while keeping measurement accuracy and precision as good as with a pure water displacement method. Accordingly, the present invention works according to a new principle ensuring very high measuring accuracy and resolution even during ultra-low gas flows.

Moreover, according to yet another embodiment of the present invention, the method involves calculating the volume of an average gas bubble by counting the number of released gas bubbles by using the bubble counter unit from a start and thus initial position of the flow cell compartment until the flow cell compartment pivots upwards to release the gas contained therein and then downwards again back to its initial position. The method according to the present invention then involves calculating the volume of an average gas bubble by first counting the number of released gas bubbles as bubble releases from its creating point. This is at the initial position. The flow cell compartment will pivot upwards to release the gas contained therein, which happens at an exact volume of gas for each flow cell opening. This means that the average volume of one single bubble can be calculated according to the present invention. By measuring the time interval between two successively released two bubbles, it is also possible to calculate and predict the dynamic variation of a gas volume and flow in a more accurate matter within one cycle of the flow cell compartment movement.

As mentioned above, apart from counting number of bubbles for each opening and closing of flow cell, according to the present invention it is also possible to estimate the size of a bubble by measuring the time length for blocking a light beam, said blocking caused by the bubble. Therefore, according to yet another specific embodiment, said method also involves estimating the size of a bubble by measuring the time length for blocking the light beam caused by the bubble. According to the present invention this may done by using a fast and high quality light emitting diode and receiver, preferably a laser beam. The received data for the time length for blocking the beam and the flow rate is utilized to find correlation to the volume of one single bubble.

Furthermore, according to yet another embodiment, said method comprises measuring a time range between two successively released gas bubbles. By doing so the dynamic variation of the gas flow can be calculated in a more accurate matter within one cycle of the flow cell compartment movement.

According to yet another embodiment, the method involves calculating the volume of an average gas bubble to self-calibrate the gas volume and flow measurement device. The self-calibration could be done for each cycle of flow cell opening and closing or as often as desired. If the duration for each flow cell opening and closing is very long, the possibility of uneven volume size of bubbles could be high. Therefore an additional calibration and/or calculating method for estimating the volume of each bubble could be implemented according to the present invention. The self-calibration may therefore also be based on information from the previous cycle's prediction about the volume of one single bubble. It could also be based on an average value for the volume from the latest or last a few number of cycles.

In accordance with the present invention, since the exact volume of gas for each flow cell opening is known, the average volume of gas bubble can be calculated by dividing the total volume with number of bubbles. Again, by measuring the time interval between two successively released two bubbles, the dynamic variation of gas flow can be calculated in more accurate matter within one cycle of the flow cell compartment movement.

If the duration for each flow cell opening and closing is very long, the possibility of uneven volume size of the bubbles is high. In this case, it is suitable to include additional the calibration/calculation method according to the present invention for estimating each bubble volume size in a more dynamic way. As described above, the present invention enables to estimate the size of bubble by measuring the time length for blocking the light beam caused by a bubble and to then find correlation of length of a bubble to its volume. These different alternatives according to the present invention provides for a very high resolution and precision of measurement for ultra-low gas volume and flows.

The flow cell volume displacement with bubble counting according to the present invention offers significant improvement on resolution for ultra-low gas volumes and flow measurements with high precision and accuracy. The resolution may be increased from around 2-9 ml up to about 0.02 ml or even lower. This opens up for measurement possibilities for any application that requires gas volume and flow measurement below a few ml per day, week or month and even lower with high accuracy and precision.

### DETAILED DESCRIPTION OF THE DRAWINGS

In FIG. 1 there is shown one embodiment of the present invention. The gas flow measuring device 1 comprises a flow cell compartment 2, in this case positioned in a closed container compartment 20. The flow cell compartment 2 has one gas accumulating agent 3, one lifting end 4 and has a pivoting element 5 enabling the flow cell compartment 2 to pivot upwards to release the gas contained therein and then downwards again to its initial position, where the flow cell compartment 2 operates by liquid displacement and according to the leverage effect. Furthermore, the gas flow measuring device 1 also comprises a bubble counter unit 6, in this case a pair of light-emitting diode and receiver positioned to ensure no contact with liquid media in the closed container compartment 20. Furthermore, the gas flow measuring device 1 comprises a gas inlet 11 and a gas outlet 12. As may be seen, in FIG. 1 there is provided a top view, front view and side view of the embodiment shown.

In relation to the flow cell compartment 2 it should be noted that this may also be positioned in an open compartment according to the present invention.

1. A gas volume and flow measurement device comprising a flow cell compartment with a definite and predefined inner geometric volume, the flow cell compartment having one gas accumulating end and one lifting end and having a pivoting element enabling the flow cell compartment to pivot upwards to release the gas contained therein and then downwards again to its initial position and operating by liquid displacement and according to the leverage effect, characterized by that said gas flow measurement device also comprises a bubble counter unit.

2. The gas volume and flow measurement device according to claim 1, wherein the bubble counter unit is arranged to count the number of gas bubbles generated and/or calculate the average size of at least some of the gas bubbles generated and/or the size of each individual bubble for each cycle of the flow cell compartment movement from its initial position to its gas releasing position.

3. The gas volume and flow measurement device according to claim 1, wherein the bubble counter unit comprises one or more of a conductivity sensor, capacitive sensor, ultrasound, camera, optical coupler or any kind of light emitting diode and receiver, IR infrared emitter and receiver and LED-photo diode and photo transistor, preferably at least a pair of light-emitting diode and receiver, more preferably such a pair of light-emitting diode and receiver is arranged on a pathway from a bubble creation point to a bubble releasing point.

4. The gas volume and flow measurement device according to claim 1, wherein the flow cell compartment is positioned in a closed container compartment where said closed container compartment is connected to the outside only via a gas inlet and a gas outlet.

5. The gas volume and flow measurement device according to claim 1, wherein the bubble counter unit is arranged more or less perpendicular to a gas bubble generation position.

6. The gas volume and flow measurement device according to claim 4, wherein the bubble counter unit is arranged more or less perpendicular to the gas inlet.

7. The gas volume and flow measurement device according to claim 4, wherein the bubble counter unit is a pair of light-emitting diode and receiver positioned to ensure no contact with liquid media in the closed container compartment.

8. A method for performing a gas analysis measurement or a gas volume and/or flow measurement, said method comprising directing a gas flow or gas sample to a gas volume and flow measurement device according to claim 1.

9. The method according to claim 8, said method involving using both the flow cell compartment and the bubble counter unit to measure the total gas volume and flow.

10. The method according to claim 8, said method involving calculating the volume of an average gas bubble by counting the number of released gas bubbles by using the bubble counter unit from a start and thus initial position of the flow cell compartment until the flow cell compartment pivots upwards to release the gas contained therein and then downwards again back to its initial position.

11. The method according to claim 8, said method also involving estimating the size of a bubble by measuring the time length for blocking a light beam, said blocking caused by the bubble.

12. The method according to claim 8, said method comprising measuring a time range between two successively released gas bubbles.

13. The method according to claim 8, wherein the method involves calculating the volume of an average gas bubble to self-calibrate the gas flow measurement device.
